(19) United States
(12) Patent Application Publication
(10) Pub. No.: US 2011/0226569 A1
(43) Pub. Date: Sep. 22, 2011

(54) ELECTRONIC MOTOR ACTUATORS BRAKE INHIBIT FOR AIRCRAFT BRAKING SYSTEM

(75) Inventor: GARRETT H. DEVLIEG, BELLEVUE, WA (US)

(73) Assignee: HYDRO-AIRE, INC., BURBANK, CA (US)

(21) Appl. No.: 12/728,133

(22) Filed: Mar. 19, 2010

(51) Int. Cl. B64C 25/44; F16D 65/34; G06F 19/00; B60T 13/74

(52) U.S. Cl. 188/158; 701/70

(57) ABSTRACT

A brake system control unit controls one of first and second portions of a wheel brakes electric brake actuators to activate one of the first and second portions of the actuators and deactivate the other during an inhibited braking mode. The control unit controls the activated portion of the brake actuators to generate a braking force greater than the commanded braking force of the brake pedal command, such as twice the commanded braking force, to compensate for the deactivated portion of the brake actuators. The inhibited braking mode is discontinued during emergency braking when the commanded braking force is greater than or equal to a predetermined braking force. The inhibited braking mode is also discontinued when failure of one or more brake actuators is detected.

### BACKGROUND OF THE INVENTION

The present invention generally relates to electric braking systems and more particularly pertains to systems for selectively inhibiting electric motor actuators for aircraft electric braking systems.

The use of electrically actuated brakes in aircraft and other vehicles is becoming increasingly common. Braking force is typically generated by the pressurization of piston actuators that are configured to compress a brake disk stack between a pressure plate and a backing plate to thereby cause the friction surfaces of adjacent disks to engage one another. Electrically actuated brakes typically apply such a clamping force to a brake pressure plate with electric motor-actuators (EMAs) instead of hydraulic pistons. This eliminates certain disadvantages associated with hydraulic brakes, such as hydraulic leaks, air entrainment in hydraulic fluid, loss of hydraulic fluid causing loss of multiple brakes, a potential for hydraulic fluid fires, and the like. Many of these electrically actuated brake systems employ multiple electric motor-actuators per brake, especially in larger vehicles, or in vehicles where redundancy is required to ensure that braking is not lost due to an electric motor-actuator failure, such as in aircraft braking systems, for example.

One disadvantage of electrically actuated braking systems is that the electric motor-actuators are relatively expensive compared to the cost of hydraulic braking systems. Particularly with aircraft braking systems that operate in a challenging environment with many wear cycles, such electrically actuated braking systems require periodic maintenance or overhaul to repair or refurbish worn parts, which increases the cost of the electrically actuated braking systems. In the case of aircraft braking systems, in which each brake may employ as many as four electric motor-actuators, and in which there may be as many as 4 to 20 brakes depending upon the size of the aircraft, the accumulated costs of utilizing such electric braking systems can be significant.

Braking systems are known that reduce the number of brake applications and hence the wear rate of carbon brakes by disabling one or more brakes during low energy, taxi brake applications. Another known system increases accuracy of clamping force of electric aircraft carbon brakes by providing a first pair of electric brake actuators with a range of low brake clamping force, to be engaged when a low brake clamping force is required, and a second pair of electric brake actuators with a range of high brake clamping force, to be engaged when a high brake clamping force is required.

However, there remains a need for a system and method for inhibiting selected electric brake actuators for braking system utilizing multiple electric brake actuators for operation of each brake, while retaining the capacity of each brake to achieve full commanded braking at all times. Since inhibiting selected electric brake actuators can change the braking “feel” compared to the braking “feel” of activation of all electric brake actuators when such electric brakes are applied, it would also be desirable to provide a system and method for inhibiting selected electric brake actuators that retains a normal braking “feel” when the selected electric brake actuators are inhibited. It would also be desirable to provide a system and method for inhibiting selected electric brake actuators that can discontinue inhibition of selected brake actuators if full commanded braking is required, or if a fault condition exists. The present invention meets these and other needs.

### SUMMARY OF THE INVENTION

Briefly, and in general terms, the present invention provides for a system and a method for conditionally inhibiting selected ones of a plurality of electric motor-actuators associated with an aircraft wheel brake, in which the capacity for full commanded braking is retained at all times. Conditionally inhibiting electrically actuated brakes utilizing multiple electric motor-actuators per brake according to the present invention can safely and successfully reduce the wear, and hence the cost, of utilizing electric motor-actuators. Reliability of the electric motor-actuators can be improved because individual electric motor-actuators would be subjected to fewer actuation cycles over a given period of time. In addition, conditionally inhibiting electrically actuated brakes utilizing multiple electric motor-actuators per brake according to the present invention ensures that the pedal “feel” remains unchanged, as compared with activation of all electric motor-actuators during braking. This also ensures that the amount of braking effort done by the electric brakes remains constant so that that the electric brakes continue to apply the same amount of braking force and continue to absorb the same amount of braking energy, as compared with activation of all electric motor-actuators during braking. Advantageously, conditionally inhibiting electrically actuated brakes utilizing multiple electric motor-actuators per brake according to the present invention ensures that all the reduction in wear cycles is equally distributed among all the electric motor-actuators. In addition, the present invention permits operation of all electric motor-actuators on a brake, regardless of clamping force command, if a failure is detected that affects any of the electric motor-actuators on that brake. This ensures that maximum available braking capability is retained following any failure condition. Furthermore, by inhibiting selected ones of multiple electric motor-actuators of electric brakes, anti-skid brake control on slippery surfaces can be improved. On aircraft in which electrically actuated brakes are also used for parking, battery drain during parking can be reduced.

While electric motor-actuators of an electric braking system must have the capacity to apply full emergency brake clamping force, the clamping force required during typical braking operations is far less than that required for full emergency braking. Therefore the present invention provides for an inhibited braking mode in which the use of one or more of the available electric motor-actuators on a brake is inhibited during normal braking operations, and an emergency braking mode and a maximum available braking mode in which more or all of the electric motor-actuators are activated when greater clamping force is needed. The brake control system includes logic to determine when selected electric motor-actuators would be inhibited or not, primarily based upon the braking level commanded. If the command is for a braking level that can be accomplished with selected electric motor-actuators inhibited, then the control system would inhibit those electric motor-actuators. If the brake pedal command signal is for a braking force that is above a threshold predetermined braking force requiring more or all of the electric motor-actuators to be activated, then the control system commands more or all of the electric motor-actuators to be activated. Conditionally inhibiting the brakes as described would safely and successfully reduce the wear, and hence the cost, of the electric motor-actuators. It would also improve the reliability of the electric motor-actuators because they would be subjected to fewer actuation cycles over a given period of time.

Accordingly, the present invention provides for a system for controlling a plurality of electric motor-actuators associated with an aircraft wheel brake. The system includes a plurality of electric motor-actuators operatively connected to an aircraft wheel brake to actuate the aircraft wheel brake. The plurality of electric motor-actuators include first and second portions of the plurality of electric motor-actuators, and an electronic brake actuation controller operatively connected to the plurality of electric motor-actuators and is configured to control the operation of the first and second portions of the plurality of electric motor-actuators. A brake system control unit is connected to the electronic brake actuation controller and is configured to receive a brake pedal command for a commanded braking force, and to control the electronic brake actuation controller, such that one of the first and second portions of the plurality of electric motor-actuators is activated and the other of the first and second portions of the plurality of electric motor-actuators is deactivated during an inhibited braking mode.

In a presently preferred aspect, the brake system control unit is configured to generate a braking force of the activated one of the first and second portions of the plurality of electric motor-actuators greater than the commanded braking force of the brake pedal command to compensate for the other of the first and second portions of the plurality of electric motor-actuators being deactivated during the inhibited braking mode. In another presently preferred aspect, when half of the plurality of electric motor-actuators are deactivated from braking notwithstanding a brake pedal command for a commanded braking force during the inhibited braking mode, the brake system control unit is configured to control the electronic brake actuation controller to cause the activated one of the first and second portions of the plurality of electric motor-actuators to generate twice the commanded braking force of the brake pedal command during the inhibited braking mode. In another presently preferred aspect, the brake system control unit is operative to discontinue the inhibited braking mode and to activate the first and second portions of the plurality of electric motor-actuators during an emergency braking mode in which the commanded braking force is greater than or equal to a predetermined braking force. In another presently preferred aspect, the brake system control unit is operative to detect failure of at least one of the plurality of electric motor-actuators, and the brake system control unit inactivates the inhibited braking mode and activates a maximum available braking mode in which the first and second portions of the plurality of electric motor-actuators are both activated, responsive to detection by the brake system control unit of the failure of the at least one of the plurality of electric motor-actuators.

The present invention also provides for a method for controlling a plurality of electric motor-actuators associated with an aircraft wheel brake, in which a brake pedal command for a commanded braking force is generated for an aircraft wheel brake, the brake pedal command is received, and the electronic brake actuation controller is controlled such that one of the first and second portions of the plurality of electric motor-actuators is activated and the other of the first and second portions of the plurality of electric motor-actuators is deactivated during an inhibited braking mode. In one presently preferred aspect, the braking force generated by the activated one of the first and second portions of the plurality of electric motor-actuators is preferably greater than the commanded braking force of the brake pedal command to compensate for the other of the first and second portions of the plurality of electric motor-actuators being deactivated during the inhibited braking mode.

In another presently preferred aspect, half of the plurality of electric motor-actuators are deactivated from braking notwithstanding a brake pedal command for a commanded braking force during the inhibited braking mode, and the brake system control unit controls the electronic brake actuation controller to cause the activated one of the first and second portions of the plurality of electric motor-actuators to generate twice the commanded braking force of the brake pedal command during the inhibited braking mode. In another presently preferred aspect, the brake system control unit inactivates the inhibited braking mode when the commanded braking force is greater than or equal to a predetermined threshold braking force.

In another presently preferred aspect, the step of controlling the electronic brake actuation controller includes controlling actuation of each of the plurality of electric motor-actuators to generate a commanded braking force according to a first pedal command vs. brake force curve when the inhibited braking mode is inactive, and controlling actuation of the activated one of the first and second portions of the plurality of electric motor-actuators to generate a commanded braking force greater than the brake pedal command during the inhibited braking mode according to a second pedal command vs. brake force curve. In another presently preferred aspect, the first and second portions of the plurality of electric motor-actuators are alternatingly activated during successive actuations of the plurality of electric motor-actuators during the inhibited braking mode.

These and other aspects and advantages of the invention will become apparent from the following detailed description and the accompanying drawings, which illustrate by way of example the features of the invention.

### BRIEF DESCRIPTION OF THE DRAWINGS

FIG. 1 is a schematic diagram of a prior art electrically actuated brake system.

FIG. 2 is a series of charts illustrating the summation of clamping force of individual electric motor-actuators during normal braking in which all electric motor-actuators are active to produce a complete brake clamping force of an electric brake system according to the prior art.

FIG. 3 is a schematic diagram of a system for controlling a plurality of electric motor-actuators of an electrically actuated brake system, according to the present invention.

FIG. 4 is a series of charts illustrating the summation of clamping force of individual electric motor-actuators of an electric brake system with two electric motor-actuators inhibited to produce a complete brake clamping force of the system of FIG. 3.

FIG. 5A is a schematic diagram illustrating a non-braking configuration of electric motor-actuators of an electric brake system in which no electric motor-actuators are activated in the system of FIG. 3.

FIG. 5B is a schematic diagram illustrating an inhibited braking configuration of electric motor-actuators of an electric brake system in which two electric motor-actuators are activated and two electric motor-actuators are inhibited in the system of FIG. 3.

FIG. 5C is a schematic diagram illustrating an emergency braking configuration of electric motor-actuators of an electric brake system in which all four of four electric motor-actuators are activated and inhibition of electric motor-actuators is discontinued in the system of FIG. 3.

FIG. 6 is a schematic diagram illustrating a sequence of configurations of alternating activation of electric motor-actuators during successive actuations of the electric motor-actuators of an electric brake system during an inhibited braking mode, in the system of FIG. 3.

### DETAILED DESCRIPTION OF THE PREFERRED EMBODIMENTS

While the use of electrically actuated brakes in aircraft and other vehicles eliminates some disadvantages associated with the use of hydraulic brakes, the accumulated costs of utilizing multiple electric motor-actuators in electrically actuated braking systems, owing to the costs of periodic maintenance, repair and replacement of worn parts hydraulic braking systems, and particularly heavy usage in aircraft braking systems that operate in challenging environments, can be significant.

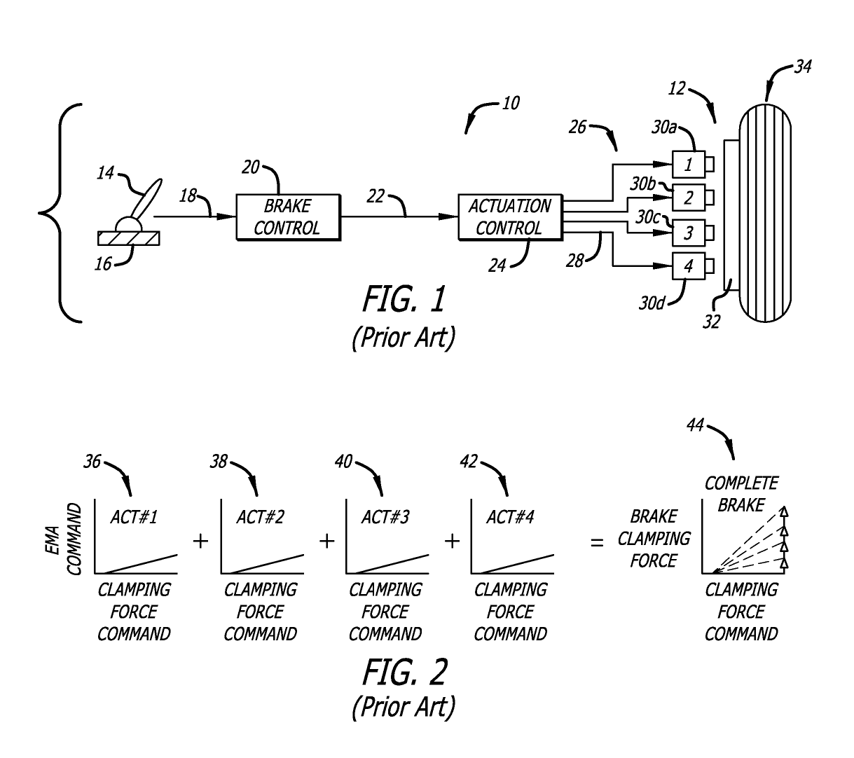

As is illustrated in FIG. 1, a prior art system 10 for controlling an electrically actuated brake system 12 typically includes an aircraft brake pedal 14 operated by a pilot (not shown), and a microcontroller 16 associated with the aircraft brake pedal. The microcontroller reads the position of the aircraft brake pedal and generates a brake pedal command signal 18, which is received by a brake system control unit (BSCU) 20. The brake system control unit in turn generates a commanded clamping force signal 22 that is received by an electronic brake actuation controller (EBAC) 24, which generates individual electric motor-actuator commands 26 conducted over a system bus 28 to a plurality of electric motor-actuators, such as four symmetrically arranged electric motor-actuators 30a,b,c,d (#1, #2, #3, #4) associated with a wheel brake 32 of a wheel 34 of a vehicle (not shown), such as an aircraft, for example.

Referring to FIG. 2, such a prior art system for controlling an electrically actuated brake system the electronic brake actuation controller electronic brake actuation controller typically actuates all of the plurality of electric motor-actuators during operation of the wheel brake, so that the brake clamping force of an electric brake system is provided by the summation of the individual clamping forces of the individual electric motor-actuators operating together in unison to produce the desired total or complete brake clamping force of the wheel brake. For an electrically actuated brake system including four symmetrically arranged electric motor-actuators 30a,b,c,d (electric motor-actuators #1, #2, #3, #4), the normal braking commanded clamping force curves 36, 38, 40 and 42 of the four symmetrically arranged electric motor-actuators 30a,b,c,d (electric motor-actuators #1, #2, #3, #4), respectively, are summed to provide the wheel brake's normal braking total or complete brake commanded clamping force curve 44.

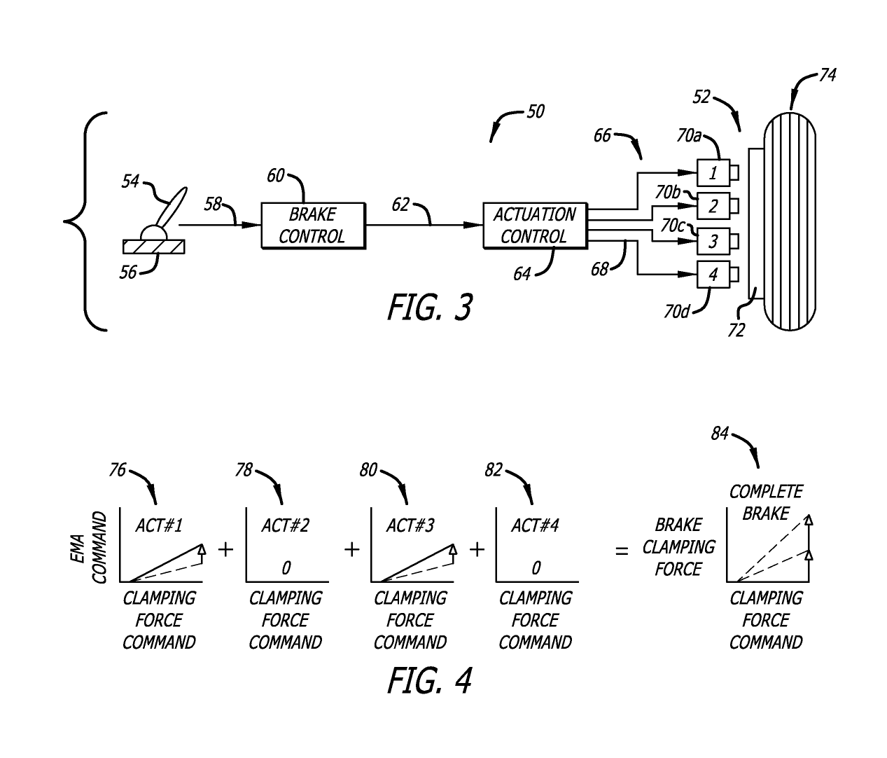

Referring to FIGS. 3-6 which are provided for purposes of illustration by way of example and not by way of limitation, the present invention provides for a system 50 for controlling an electrically actuated brake system 52 for one or more wheel brakes of an aircraft or other vehicle. As is illustrated in FIG. 3, the electrically actuated brake system typically includes an aircraft brake pedal 54 operated by a pilot (not shown), and a microcontroller 56 associated with the aircraft brake pedal. The microcontroller reads the position of the aircraft brake pedal and generates a brake pedal command signal 58, which is received by a brake system control unit (BSCU) 60. The brake system control unit in turn generates a commanded clamping force signal 62 that is received by an electronic brake actuation controller (EBAC) 64, which generates individual electric motor-actuator commands 66 conducted over a system bus 68 to a plurality of electric motor-actuators, such as four symmetrically arranged electric motor-actuators 70a,b,c,d (#1, #2, #3, #4) associated with a wheel brake 72 of a wheel 74 of a vehicle (not shown), such as an aircraft, for example.

Referring to FIGS. 3 to 5C, the plurality of electric motor-actuators include a first portion 86 of the plurality of electric motor-actuators, such as two of a total of four electric motor-actuators that can be applied, for example electric motor-actuator 70a, and 70c (#1 and #3), and a second portion 88 of the plurality of electric motor-actuators, such as the other two of the total of four electric motor-actuators that can be applied, for example electric motor-actuator 70b and 70d (#2 and #4), or electric motor-actuator 70a, and 70c (#1 and #3). Alternatively, the first portion of the plurality of electric motor-actuators can be formed by electric motor-actuator 70b and 70d (#2 and #4), while the second portion the plurality of electric motor-actuators would be formed by electric motor-actuator 70a, and 70c (#1 and #3), for example, but the electric motor-actuators are preferably segregated into symmetrically arranged groups, for balanced operation of the wheel brake.

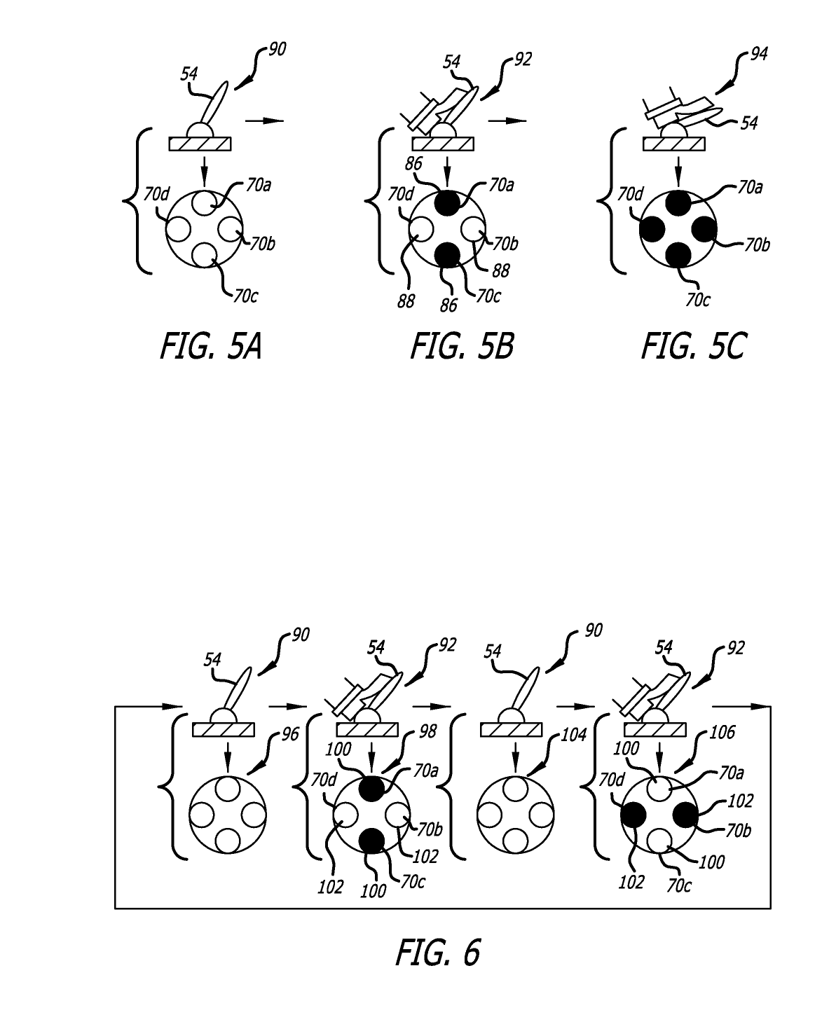

As is illustrated in FIG. 5A, neither of the first or second portions of the plurality of electric motor-actuators are actuated when the brake pedal is not applied 90. As is illustrated in FIG. 5B, when the brake pedal is applied 92 during inhibited braking mode with a commanded clamping force less than a predetermined threshold, one of the first and second portions of the plurality of electric motor-actuators, such as two of four electric motor-actuators applied, for example electric motor-actuator 70a, and 70c (#1 and #3,), or electric motor-actuator 70b and 70d (#2 and #4), is activated, while the other of the first and second portions of the plurality of electric motor-actuators is deactivated during an inhibited braking mode.

As is illustrated in FIG. 4, the brake system control unit is configured to control the electronic brake actuation controller such that one of the first and second portions of the plurality of electric motor-actuators is activated and the other of the first and second portions of the plurality of electric motor-actuators is deactivated during an inhibited braking mode. For an electrically actuated brake system of the invention including four symmetrically arranged electric motor-actuators 70a,b,c,d (electric motor-actuators #1, #2, #3, #4), the inhibited braking mode commanded clamping force curves normal braking commanded clamping force curves 76, 78, 80 and 82 of the four symmetrically arranged electric motor-actuators 70a,b,c,d (electric motor-actuators #1, #2, #3, #4) are summed by operation of the system to provide the wheel brake's normal braking total or complete brake commanded clamping force curve 84.

However, during the inhibited braking mode, only one of the selected first or second portions of the plurality of electric motor-actuators contribute to provide the wheel brake's normal braking total or complete brake commanded clamping force curve, while the other of the first and second portions of the plurality of electric motor-actuators that is inhibited do not contribute to the wheel brake's normal braking total or complete brake commanded clamping force curve. This would result in an objectionable change in braking “feel” to the vehicle operator between the times when electric motor-actuators are inhibited vs. not inhibited and during transitions between the two. Accordingly, the brake system control unit is preferably configured to generate a braking force of the activated one of the first and second portions of the plurality of electric motor-actuators greater than the commanded braking force of the brake pedal command to compensate for the other of the first and second portions of the plurality of electric motor-actuators being deactivated during the inhibited braking mode, so that the braking “feel” is the same whether the brakes are inhibited or not.

The brake system control unit preferably controls the electronic brake actuation controller to cause the activated one of the first and second portions of the plurality of electric motor-actuators to generate a braking force of greater than the commanded braking force in direct proportion to the number of electric motor-actuators that are inhibited. Where each of the first and second portions of the plurality of electric motor-actuators constitute half of the plurality of electric motor-actuators, so that half of the plurality of electric motor-actuators are deactivated from braking during the inhibited braking mode notwithstanding a brake pedal command for a commanded braking force, the brake system control unit preferably controls the electronic brake actuation controller to cause the activated one of the first and second portions of the plurality of electric motor-actuators to generate twice the commanded braking force of the brake pedal command during the inhibited braking mode. This ensures that the pedal “feel” experienced by an operator of the electronic wheel braking system remains unchanged. This also ensures that the amount of braking effort produced by the wheel brake applies the same amount of braking force and continues to absorb the same amount of braking energy as when all of the available electric motor-actuators are activated together.

The brake system control unit preferably discontinues the inhibited braking mode and activates the first and second portions of the plurality of electric motor-actuators during an emergency braking mode when the commanded braking force is greater than or equal to a predetermined braking force. Referring to FIG. 5C, when the brake pedal is applied during emergency braking mode 94 with a commanded clamping force greater than or equal to the predetermined threshold, all of the plurality of available electric motor-actuators are applied, and when four electric motor-actuators are provided, for example, four of the four electric motor-actuators, electric motor-actuators 70a,b,c,d (#1, #2, #3, #4), are applied during emergency braking mode.

Another important concern is that the response of the electronic braking system to failure conditions, in aircraft, as well as other vehicles, should include the ability to continue safe operation of the braking system after a failure of one or more of the electric motor-actuators occurs so that repairs can be deferred to a time when those repairs can be made. Accordingly, in the present invention the brake system control unit is operative to detect failure of one or more of the plurality of electric motor-actuators, and the brake system control unit inactivates the inhibited braking mode and activates a maximum available braking mode in which all of the available electric motor-actuators in the first and second portions of the plurality of electric motor-actuators are activated, responsive to detection of failure of one or more of the electric motor-actuators. For example, if the brake system control unit detects that an electric motor-actuator associated with a brake is inoperative, the brake system control unit would then cease to inhibit any of the other electric motor-actuators on that brake until repairs are made. This ensures that maximum available braking capability is retained following any failure condition. Since operation with a failure condition is infrequent, the effect on cost, wear, and reliability would be negligible. In addition, if a failure condition of one or more of the plurality of electric motor-actuators is detected, or one or more of the plurality of electric motor-actuators otherwise become inoperative and the other electric motor-actuators on that brake are commanded to be operative, then the command to the operative electric motor-actuators can be adjusted by the brake system control unit as noted above to ensure no overall change in brake “feel.”

Another important consideration is that if the electric motor-actuator inhibit logic always inhibits the same electric motor-actuators, then the full-time electric motor-actuators would wear out far more rapidly than the inhibited ones, which may be undesirable. The invention also allows for logic that would periodically change which electric motor-actuators are inhibited and which are not. One way to do this for aircraft applications would be to switch every flight cycle as indicated by landing gear extension or some other indication of a flight cycle. A more preferred way would be to switch every time the clamping force command to that brake is removed, in other words every time the brake is released. As is illustrated in FIG. 6, alternating electric motor-actuator selection during inhibited braking mode involves a continuous cycle of alternating activation and deactivation of the first and second portions of the plurality of electric motor-actuators. Thus, following a first non-braking configuration 96 in which the brake pedal is not applied and no electric motor-actuators are activated, when the brake pedal is applied during the inhibited braking mode and the brake system control unit receives a brake pedal command, the brake system control unit controls the electronic brake actuation controller to actuate the electric motor-actuators in a first braking configuration 98 in which a first portion 100 of the plurality of electric motor-actuators, such as two of four electric motor-actuators, such as electric motor-actuator 70a and 70c (#1 and #3,), is activated, while a second portion 102 of the plurality of electric motor-actuators, such as the remaining two of four electric motor-actuators, such as electric motor-actuator 70b and 70d (#2 and #4), is deactivated. Thereafter, when the brake pedal command signal ceases, the electric motor-actuators assume a second non-braking configuration 104 in which no electric motor-actuators are activated, and when the brake system control unit subsequently receives a brake pedal command, the brake system control unit controls the electronic brake actuation controller to actuate the electric motor-actuators in a second braking configuration 106 in which the second portion 102 of the plurality of electric motor-actuators, i.e. electric motor-actuator 70b and 70d (#2 and #4), is activated while the first portion 100 of the plurality of electric motor-actuators, i.e. electric motor-actuator 70a and 70c (#1 and #3,), is deactivated. This logic provides the most even distribution of electric motor-actuator usage and does not require any additional vehicle logic data to implement. This ensures that all the reduction in wear cycles provided by the inhibit feature is equally distributed among all the electric motor-actuators.

Conditionally inhibiting selected electric motor-actuators when all electric motor-actuators are not needed can also improve brake control on slippery surfaces, and can reduce battery drain during parking. When braking is required on low friction surfaces such as wet pavement or ice, for example, very little clamping force is required to apply an optimum level of braking. When all the electric motor-actuators are operating together, antiskid-controlled braking becomes difficult because only a tiny change in clamping force command causes a large change in actual clamping force. With a portion of available electric motor-actuators inhibited, the same clamping force command causes a proportionately smaller change to the actual clamping force. As a result, the brake control system can more accurately and effectively control braking on slippery surfaces.

Battery drain during parking of aircraft can be reduced. In aircraft, electrically actuated brakes are also used for parking. After the parking brake is set, the brake system control unit continues to operate while the brakes cool. This is necessary because the brake system control unit must periodically re-adjust the electric motor-actuators to account for thermal contractions of the brake, which can take as long as an hour. The brake system control unit must use aircraft battery power during this period of control braking during parking, since that is the only electrical power source available to operate the electric motor-actuators when the aircraft is shut down. This has a significant effect on sizing the battery. It is usually only necessary to apply full clamping force with the parking brake when the engines are running, and at such times electrical power for operating the electric motor-actuators comes from the electrical generators on the engine, not from the battery. The only time when the parking brake must be powered by the battery is when the engines are not operating, and only partial clamping force is necessary at such times. This allows some electric motor-actuators to be inhibited when parking on battery power. By doing so, the power drain on the battery is significantly reduced.

It will be apparent from the foregoing that while particular forms of the invention have been illustrated and described, various modifications can be made without departing from the spirit and scope of the invention. Accordingly, it is not intended that the invention be limited, except as by the appended claims.

I claim:

1. A system for controlling a plurality of electric motor-actuators associated with an aircraft wheel brake, the system comprising:
a plurality of electric motor-actuators, said plurality of electric motor-actuators including a first portion of said plurality of electric motor-actuators and a second portion of said plurality of electric motor-actuators, said plurality of electric motor-actuators being operatively connected to an aircraft wheel brake to actuate the aircraft wheel brake;
an electronic brake actuation controller operatively connected to said plurality of electric motor-actuators and configured to control the operation of said first and second portions of said plurality of electric motor-actuators; and
a brake system control unit configured to receive a brake pedal command for a commanded braking force, said brake system control unit being connected to said electronic brake actuation controller and configured to control said electronic brake actuation controller, such that one of said first and second portions of said plurality of electric motor-actuators is activated and the other of said first and second portions of said plurality of electric motor-actuators is deactivated during an inhibited braking mode.

2. The system of claim 1, wherein said brake system control unit is configured to generate a braking force of the activated one of said first and second portions of said plurality of electric motor-actuators greater than the commanded braking force of the brake pedal command to compensate for said other of said first and second portions of said plurality of electric motor-actuators being deactivated during said inhibited braking mode.

3. The system of claim 1, wherein half of said plurality of electric motor-actuators are deactivated from braking notwithstanding a brake pedal command for a commanded braking force during said inhibited braking mode, and wherein said brake system control unit is configured to control said electronic brake actuation controller to cause said activated one of said first and second portions of said plurality of electric motor-actuators to generate twice the commanded braking force of the brake pedal command during said inhibited braking mode.

4. The system of claim 1, wherein said brake system control unit is operative to discontinue said inhibited braking mode and activate said first and second portions of said plurality of electric motor-actuators during an emergency braking mode in which said commanded braking force is greater than or equal to a predetermined braking force.

5. The method of claim 1, wherein said brake system control unit is operative to detect failure of at least one of said plurality of electric motor-actuators, and wherein said brake system control unit is configured to inactivate said inhibited braking mode and activate a maximum available braking mode in which said first and second portions of said plurality of electric motor-actuators are both activated, responsive to detection by said brake system control unit of said failure of said at least one of said plurality of electric motor-actuators.

6. A method for controlling a plurality of electric motor-actuators associated with an aircraft wheel brake, the aircraft brake system including a plurality of electric motor-actuators, said plurality of electric motor-actuators including a first portion of said plurality of electric motor-actuators and a second portion of said plurality of electric motor-actuators, said plurality of electric motor-actuators being operatively connected to an aircraft wheel brake to actuate the aircraft wheel brake, an electronic brake actuation controller operatively connected to said plurality of electric motor-actuators and configured to control the operation of said first and second portions of said plurality of electric motor-actuators, and a brake system control unit configured to receive a brake pedal command for a commanded braking force, said brake system control unit being connected to said electronic brake actuation controller and configured to control said electronic brake actuation controller, the method comprising:
generating a brake pedal command for a commanded braking force for an aircraft wheel brake;
receiving said brake pedal command; and
controlling said electronic brake actuation controller in an inhibited braking mode such that one of said first and second portions of said plurality of electric motor-actuators is activated and the other of said first and second portions of said plurality of electric motor-actuators is deactivated.

7. The method of claim 6, further comprising the step of generating a braking force of the activated one of said first and second portions of said plurality of electric motor-actuators greater than the commanded braking force of the brake pedal command to compensate for said other of said first and second portions of said plurality of electric motor-actuators being deactivated during said inhibited braking mode.

8. The method of claim 7, wherein half of said plurality of electric motor-actuators are deactivated from braking notwithstanding a brake pedal command for a commanded braking force during said inhibited braking mode, said brake system control unit controlling said electronic brake actuation controller to cause said activated one of said first and second portions of said plurality of electric motor-actuators to generate twice the commanded braking force of the brake pedal command during said inhibited braking mode

9. The method of claim 6, wherein said brake system control unit is operative to discontinue said inhibited braking mode when said commanded braking force is greater than or equal to a predetermined braking force.

10. The method of claim 6, wherein said brake system control unit inactivates said inhibited braking mode and activates an emergency braking mode in which said first and second portions of said plurality of electric motor-actuators are both activated when said commanded braking force is greater than or equal to a predetermined braking force.

11. The method of claim 6, wherein said brake system control unit is operative to detect failure of at least one of said plurality of electric motor-actuators, and wherein said brake system control unit inactivates said inhibited braking mode and activates a maximum available braking mode in which said first and second portions of said plurality of electric motor-actuators are both activated, responsive to detection by said brake system control unit of said failure of said at least one of said plurality of electric motor-actuators.

12. The method of claim 6, wherein said first and second portions of said plurality of electric motor-actuators are alternatingly activated during successive actuations of said plurality of electric motor-actuators during said inhibited braking mode.

13. A method for controlling a plurality of electric motor-actuators associated with an aircraft wheel brake, the aircraft brake system including a plurality of electric motor-actuators, said plurality of electric motor-actuators including a first portion of said plurality of electric motor-actuators and a second portion of said plurality of electric motor-actuators, said plurality of electric motor-actuators being operatively connected to an aircraft wheel brake to actuate the aircraft wheel brake, an electronic brake actuation controller operatively connected to said plurality of electric motor-actuators and configured to control the operation of said first and second portions of said plurality of electric motor-actuators, and a brake system control unit configured to receive a brake pedal command for a commanded braking force, said brake system control unit being connected to said electronic brake actuation controller and configured to control said electronic brake actuation controller, such that one of said first and second portions of said plurality of electric motor-actuators is activated and the other of said first and second portions of said plurality of electric motor-actuators is deactivated during an inhibited braking mode, the method comprising:
generating a brake pedal command for a commanded braking force for an aircraft wheel brake;
receiving said brake pedal command and controlling said electronic brake actuation controller such that one of said first and second portions of said plurality of electric motor-actuators is activated and the other of said first and second portions of said plurality of electric motor-actuators is deactivated during an inhibited braking mode; and
generating a braking force of the activated one of said first and second portions of said plurality of electric motor-actuators greater than the commanded braking force of the brake pedal command to compensate for said other of said first and second portions of said plurality of electric motor-actuators being deactivated during said inhibited braking mode.

14. The method of claim 13, wherein half of said plurality of electric motor-actuators are deactivated from braking notwithstanding a brake pedal command for a commanded braking force during said inhibited braking mode, said brake system control unit controlling said electronic brake actuation controller to cause said activated one of said first and second portions of said plurality of electric motor-actuators to generate twice the commanded braking force of the brake pedal command during said inhibited braking mode

15. The method of claim 13, wherein said brake system control unit is operative to discontinue said inhibited braking mode when said commanded braking force is greater than or equal to a predetermined braking force.

16. The method of claim 13, wherein said brake system control unit inactivates said inhibited braking mode and activates an emergency braking mode in which said first and second portions of said plurality of electric motor-actuators are both activated when said commanded braking force is greater than or equal to a predetermined braking force.

17. The method of claim 13, further comprising the step of controlling actuation of each of said plurality of electric motor-actuators to generate a commanded braking force according to a first pedal command vs. brake force curve when the inhibited braking mode is inactive, and controlling actuation of said activated one of said first and second portions of said plurality of electric motor-actuators to generate a commanded braking force greater than the brake pedal command during said inhibited braking mode according to a second pedal command vs. brake force curve.

18. The method of claim 17, wherein said second pedal command vs. brake force curve applies twice the brake force for a given brake pedal application.

19. The method of claim 13, wherein said brake system control unit is operative to detect failure of at least one of said plurality of electric motor-actuators, and wherein said brake system control unit inactivates said inhibited braking mode and activates a maximum available braking mode in which said first and second portions of said plurality of electric motor-actuators are both activated, responsive to detection by said brake system control unit of said failure of said at least one of said plurality of electric motor-actuators.

20. The method of claim 13, wherein said first and second portions of said plurality of electric motor-actuators are alternatingly activated during successive actuations of said plurality of electric motor-actuators during said inhibited braking mode.
